(19) United States
(12) Patent Application Publication
(10) Pub. No.: US 2008/0059896 A1
(43) Pub. Date: Mar. 6, 2008

(54) Mobile Device User Interface

(75) Inventors: Christine Anderson, San Jose, CA (US); Darren A. Apfel, Redmond, WA (US); Sandra G. Hirsh, Palo Alto, CA (US); Andre Mohr, Seattle, WA (US); Cinthya R. Urasaki, Seattle, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/468,713

(22) Filed: Aug. 30, 2006

(51) Int. Cl. G06F 3/048

(52) U.S. Cl. 715/764

(57) ABSTRACT

A mobile device user interface is described. Data tiles are arranged as a stack of wheels, where each wheel has one or more data tiles. One data tile from each wheel is simultaneously displayed. Up/down navigation is used to move from one wheel to another, while left/right navigation is used to spin a wheel to view the data tiles on the current wheel.

### BACKGROUND

Many mobile devices such as, but not limited to, cell phones, smart phones, personal digital assistants (PDAs), and digital music players, are implemented to provide user access to large amounts of data, such as via the Internet. Many such mobile devices typically provide a relatively small screen via which a visual user interface to view the available data may be presented to a user. Typical implementations provide a user interface that includes selectable list-based menus and submenus wherein to access a specific type of data a user drills down through the menu system to access the desired data. Alternatively, a large amount of data may be presented as a single page (not as discrete, independently scrollable modules within the page) with only a small portion of the page viewable at any given time. In this scenario, the user scrolls the entire page of content left and right and/or up and down to access all of the data on the page.

### SUMMARY

This Summary is provided to introduce a selection of concepts in a simplified form that are further described below in the Detailed Description. This Summary is not intended to identify key features or essential features of the claimed subject matter, not is it intended to be used as an aid in determining the scope of the claimed subject matter.

A mobile device user interface is described. The user interface is arranged as a stack of wheels, with each wheel having one or more data tiles. One data tile from each wheel is simultaneously viewable, and each wheel spins independent of the other wheels to allow a user to view each of the data tiles on a particular wheel. The wheel-based user interface has a memory in the sense that if a user navigates away from the wheel-based user interface, and later navigates back to it, the position of each of the wheels remains unchanged. In an exemplary implementation, the wheel-based mobile device user interface maps to a row-column structure of modules of data on a web page, such that each data tile on a particular wheel maps to a data module in a particular column on the web page.

### BRIEF DESCRIPTION OF THE DRAWINGS

FIG. 1 is a pictorial diagram that illustrates an exemplary environment in which a mobile device user interface may be implemented.

FIG. 2 is a block diagram that illustrates select components of an exemplary mobile device.

FIG. 3 is a block diagram that illustrates an exemplary mobile device user interface that presents data arranged in wheels of data tiles.

FIG. 4 is a block diagram that illustrates exemplary navigation among data tiles that may be associated with a wheel of a mobile device user interface.

FIG. 5 is a block diagram that illustrates exemplary navigation between wheels of an exemplary mobile device user interface.

FIG. 6 is a block diagram that illustrates independence of each wheel of an exemplary mobile device user interface.

FIG. 7 is a block diagram that illustrates selection of a data tile to activate an exemplary detailed view of the data tile

FIG. 8 is a block diagram that illustrates an exemplary mapping between data tiles arranged in a full screen web-page and data tiles in a wheel-based mobile device user interface.

FIG. 9 is a pictorial diagram that illustrates exemplary wheel position indicators.

FIG. 10 is a pictorial diagram that illustrates an exemplary wheel position indicator via which alerts can be visually presented.

FIG. 11 is a flow diagram that illustrates an exemplary method for implementing a mobile device user interface.

### DETAILED DESCRIPTION

The embodiments described below provide techniques for implementing a mobile device user interface that enables intuitive navigation of various types of data.

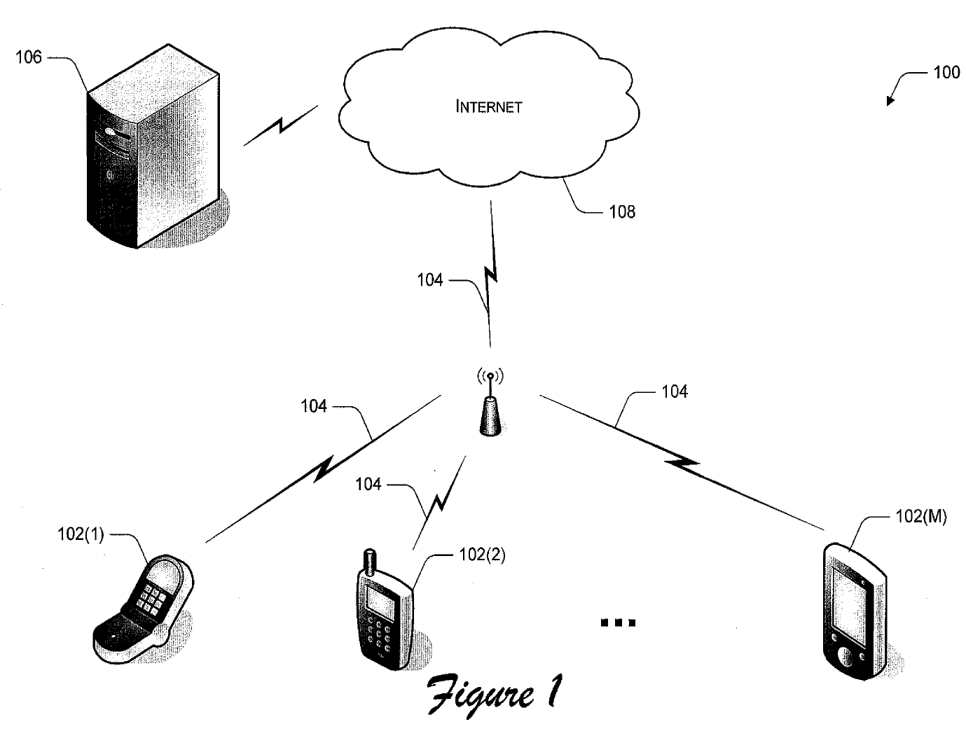

FIG. 1 illustrates an exemplary environment 100 in which a mobile device user interface as described herein may be implemented. Exemplary environment 100 includes any number of mobile devices 102, such as cell phone 102(1), smart phone 102(2), and personal digital assistant (PDA) 102(M). Mobile devices 102 are configured to communicate with other devices via wireless communication network 104. One or more of mobile devices 102 are also configured to communicate with a web server 106 via the Internet 108.

Mobile devices can come in various forms including, but not limited to, cell phones, smart phones, personal digital assistants, and so on. Furthermore, mobile devices may have multiple functionality, such as any combination of pagers, digital cameras, portable audio players, portable video players, portable gaming devices, and personal digital assistants with note taking, email, instant messaging, text messaging, multimedia messaging, contacts list, and calendar features.

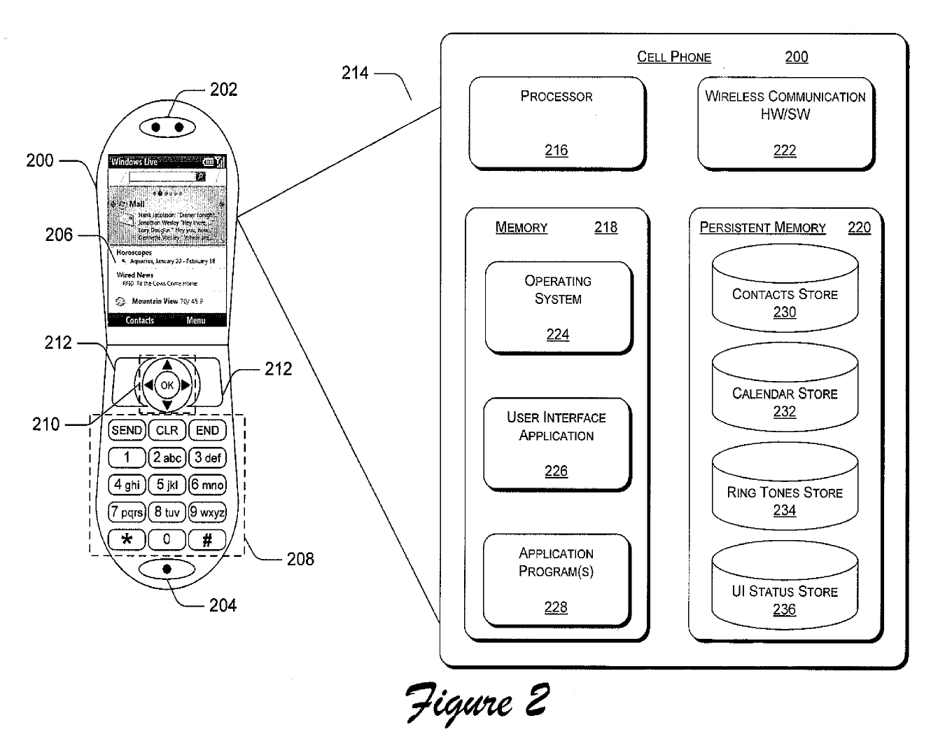

FIG. 2 illustrates select components of an exemplary mobile device, shown for illustrative purposes, as a cell telephone 200. The physical interface of cell phone 200 includes an earpiece 202, a mouthpiece 204, a display 206, a keypad 208, navigation buttons 210, and soft key buttons 212.

Block 214 illustrates select components of exemplary cell phone 200. Exemplary cell phone 200 includes a processor 216, memory 218, persistent memory 220, and wireless communication hardware and software 222.

Wireless communication hardware and software 222 includes components typically found in mobile telephones that enable the phone to communicate via a wireless telecommunications network. Operating system 224, user interface application 226, and one or more other application programs 228 are stored in memory 220 and executed on processor 218. These components enable user interaction with cell phone 200, for example, to place and receive phone calls, view data available via the Internet, manage contact data, play games, and so on.

Data stored in persistent memory may include, but is not limited to, contacts data (e.g., names and phone numbers) maintained in contacts store 230, calendar data (e.g., daily schedules) maintained in calendar store 232, ring tones (e.g., different melodies and/or sounds that can be selected to indicate an incoming phone call) maintained in ring tones store 234, and user interface data maintained in UI status store 236. User interface data may include, for example, positions associated with each of the user interface wheels and user preferences (e.g., colors, themes, font, font size, etc.) so that if a user navigates away from the wheel-based user interface and then later navigates back, the wheel positions and user preferences remain the same.

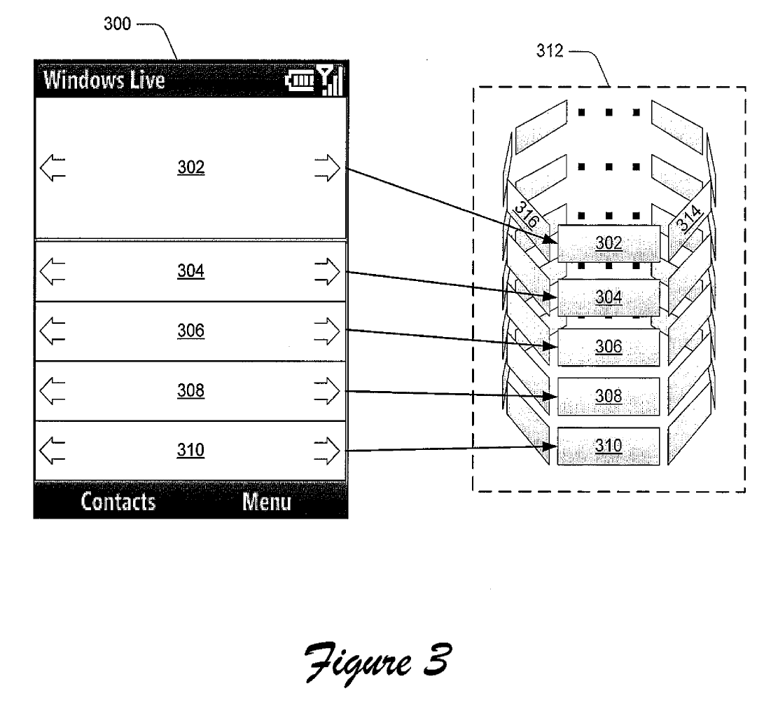

FIG. 3 illustrates an exemplary mobile device user interface 300 that presents data arranged in data tiles 302, 304, 306, 308, 310. In an exemplary implementation, the data tile that is currently highlighted, or has focus, is larger than the other tiles that are not currently highlighted. For example, as shown in FIG. 3, tile 302 is larger that tiles 304, 306, 308, and 310.

As illustrated by structure 312, each tile that is currently displayed is associated with a wheel that may include any number of additional tiles. The additional tiles can be accessed by rotating a wheel to the left or to the right. In the illustrated example, the top wheel currently has the focus. Accordingly, a right arrow command will cause the top wheel to spin clockwise, revealing tile 314 on the mobile device user interface 300. Similarly, a left arrow command will cause the top wheel to spin counter-clockwise, revealing tile 316 on the mobile device user interface 300.

Each wheel spins independently of the others, and when a user navigates up or down to another wheel, the previous wheel remains in its current location. In an exemplary implementation, a tile from each of the wheels is simultaneously visible on the mobile device user interface 300. Accordingly, the number of wheels is limited only by the vertical size of the display screen of the mobile device. In this way, there is no vertical scrolling needed to access all of the available data tiles. In an alternate implementation, the number of wheels may be larger than the number of tiles that can be simultaneously displayed. Each wheel can have any number of associated tiles, which, as described above, are accessed via left and right commands that cause a wheel to spin one tile into view at a time.

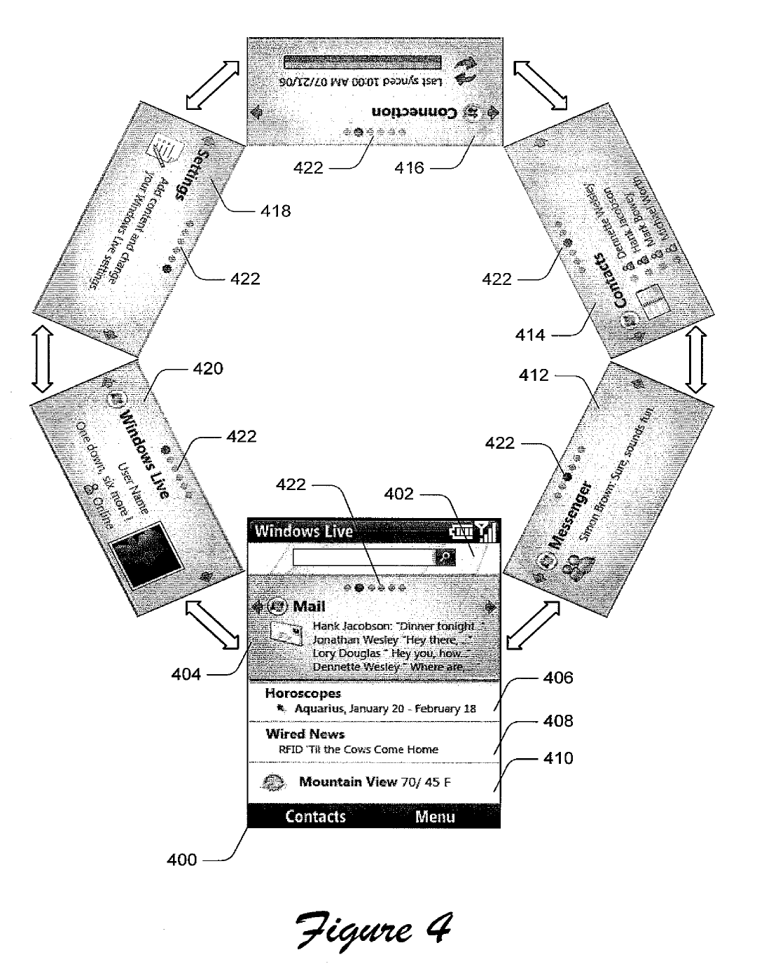

FIG. 4 illustrates exemplary navigation among data tiles that may be associated with a wheel of a mobile device user interface 400. Data tiles 402, 404, 406, 408, and 410 are currently displayed. Data tile 404 is currently highlighted, indicating that tile 404 currently has focus. Left and/or right commands can be entered to navigate among data tiles 404, 412, 414, 416, 418, and 420. In an exemplary implementation, wheel position indicator 422 provides a visual indicator of the currently displayed tile's position on the wheel. For example, wheel position indicator 422 indicates that there are six data tiles on the current wheel, and that tile 404 is located in the second position on the wheel. Similarly, tile 412 is located in the third position on the wheel; tile 414 is located in the fourth position on the wheel; and so on. Because each wheel spins independently, navigating among data tiles 404, 412, 414, 416, 418, and 420 does not affect data tiles 402, 406, 408, and 410.

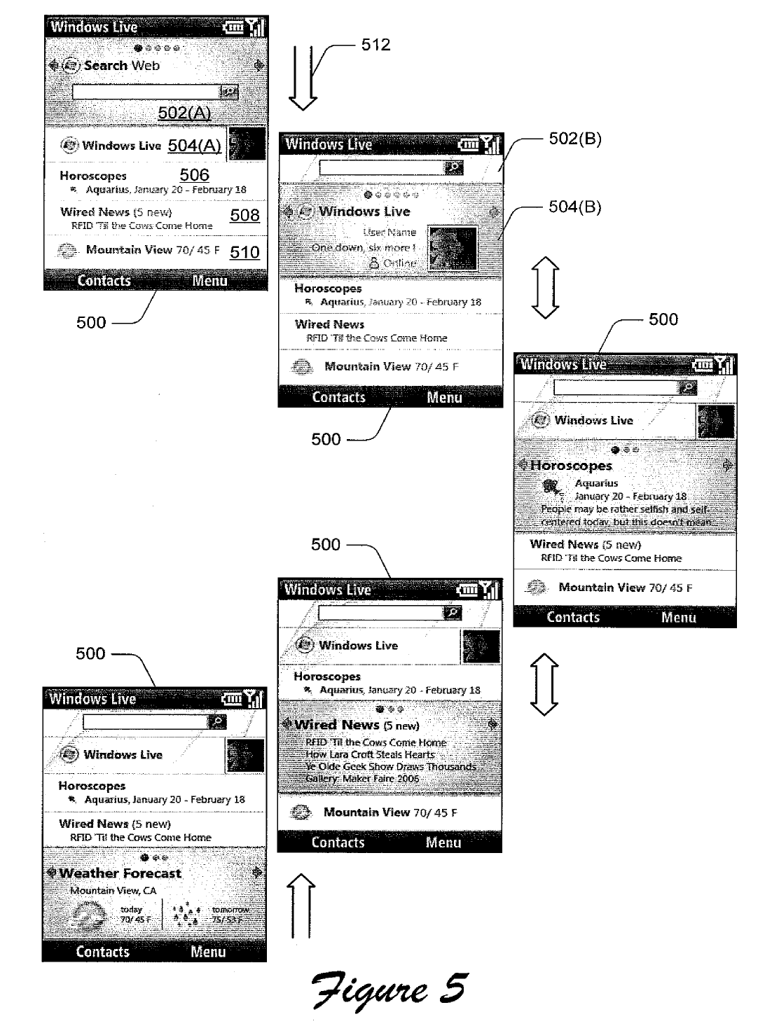

FIG. 5 illustrates navigation between wheels of an exemplary mobile device user interface 500. In an exemplary implementation, up and down commands are used to navigate between the wheels for which tiles are displayed on the mobile device user interface 500. In the illustrated example, tiles for five wheels are displayed. When the top tile 502 is highlighted, indicating that the top tile 502 (and the top wheel) has the focus, the top tile 502 is displayed in a larger area than the other tiles 504, 506, 508, and 510. Entering a down command (indicated in FIG. 5 by down arrow 512) causes the focus to move to tile 504 (and the second wheel). Accordingly, the size of tile 504 is expanded and the size of tile 502 is reduced. Similarly, as illustrated in FIG. 5, up and down commands can be used to navigate between the displayed tiles of each of the wheels. Because, in an exemplary implementation, one tile from each of the available wheels are displayed simultaneously, without requiring vertical scrolling beyond the displayable area, no up command is available when the top wheel has the focus. Similarly, no down command is available when the bottom wheel has the focus. In an alternate implementation, an up command entered when the top wheel has the focus may move the focus to the bottom wheel; and a down command entered when the bottom wheel has the focus may move the focus to the top wheel. Alternatively, whether or not an up command is available while the top wheel has the focus and whether or not a down command is available while the bottom wheel has the focus may be a user-customizable setting.

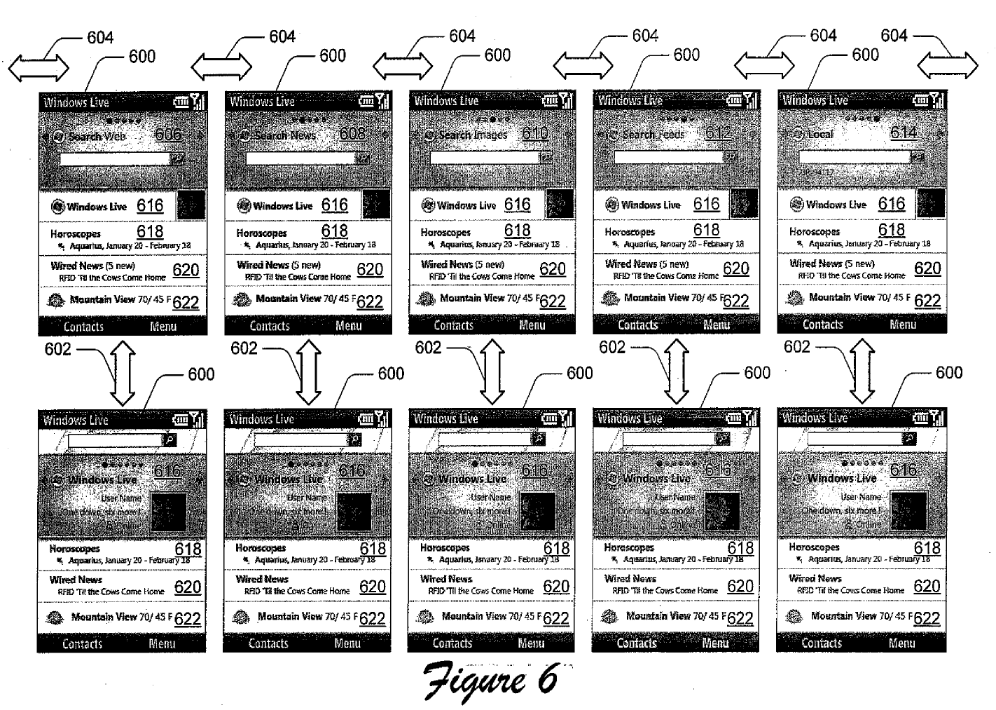

FIG. 6 illustrates the independence of each wheel of the mobile device user interface 600. The arrows shown in FIG. 6 represent navigation commands that may be received. As described above with reference to FIG. 5, the up and down navigation commands (represented by up and down arrows 602) shift the focus between the available wheels of data tiles. When the top wheel has the focus, the left and right navigation commands (represented by right and left arrows 604) cause the current wheel to spin, as described above with reference to FIG. 4. FIG. 6 illustrates that when the top wheel is spun, revealing tiles 606, 608, 610, 612, and 614, displayed tiles 616, 618, 620, and 622 are not modified. In other words, each wheel spins independently, without affecting the other wheels. Furthermore, FIG. 6 also illustrates that each wheel maintains its position when navigation moves the focus to another wheel. In other words, if the first wheel is spun to reveal data tile 608 and then the focus is moved down to the second wheel (i.e., tile 616), when the focus is moved back up to the first wheel, data tile 608 is still displayed. Furthermore, in an exemplary implementation, if the user navigates away from the wheel-based portion of the interface, when the user navigates back to the wheel-based portion of the interface, the previous positions of each of the wheels is maintained. In an alternate implementation, each wheel has a default position to which the wheel is set each time the user accesses the wheel-based portion of the user interface.

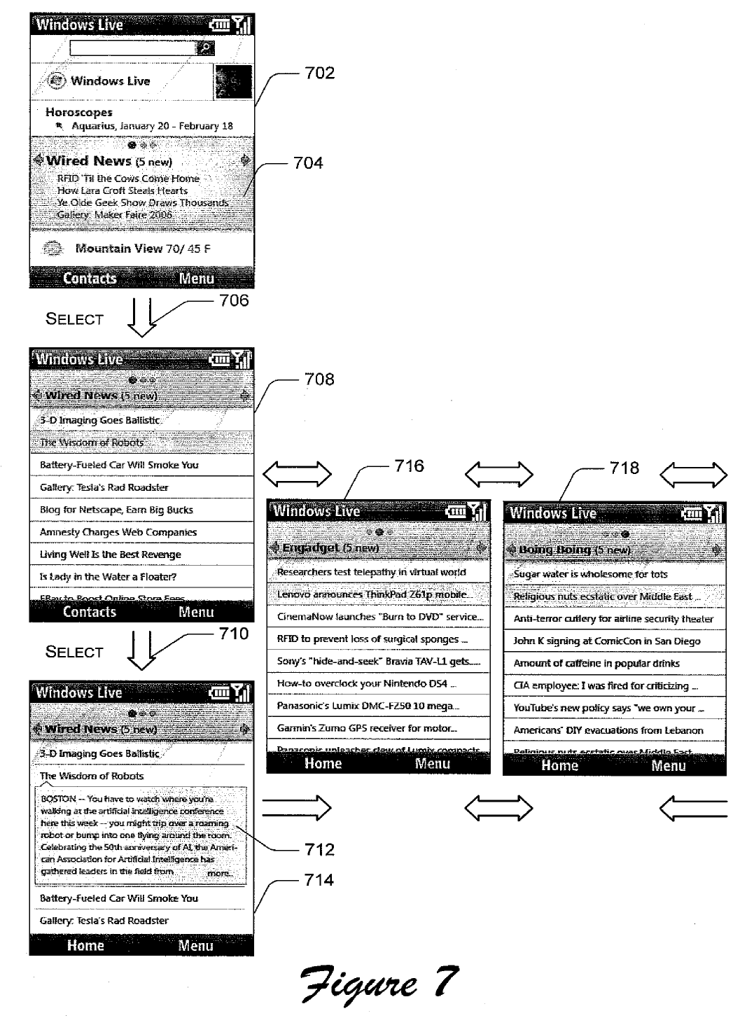

FIG. 7 illustrates selection of a data tile to activate a detailed view of the data tile. Mobile device user interface 702 illustrates a scenario in which a fourth wheel, having three data tiles currently has focus. When a user selects the currently highlighted tile 704, as indicated by arrow 706, detailed view 708 is displayed. While data tile 704 shows only four lines of detail data, detailed view 708 shows more lines of detail data, and enables the user to scroll up and down to see additional detailed data. If the user selects a particular element of the detailed data, as indicated by arrow 710, details 712 are displayed. In an exemplary implementation, while detailed view 708 or detailed view 714 are displayed, left and right navigation causes the fourth wheel to spin, revealing detailed views of each data tile associated with the fourth wheel, such as detailed view 716 and detailed view 718.

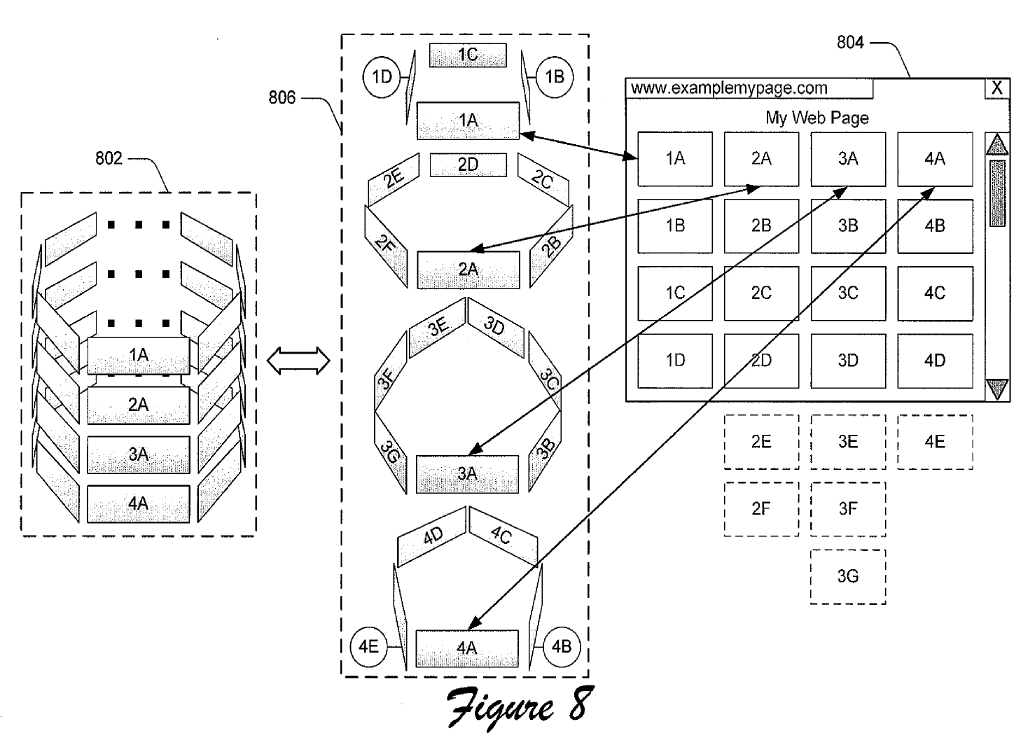

FIG. 8 illustrates an exemplary implementation of a mobile-device user interface in which data modules arranged in a fall screen web-page are mapped to a wheel-based mobile device user interface. “Data modules”, as described herein may also be referred to as “data tiles”, “containers”, or any other terminology that describes a distinct, bounded, area containing a particular type of data. Examples of web sites that utilize data modules include personal web pages like those available through Windows Live™ Spaces (www.spaces.live.com) and MySpace (www.myspace.com), and portals that can be personalized such as Google™ personalized home page (www.google.com) and Windows Live™ (www.live.com). Many web sites allow a user to personalize the presentation of data by providing a grid of rows and columns in which various data modules may be placed. Users typically arrange data modules such that those of most interest to the user are placed near the top of the grid, while data modules of less interest to the user are placed near the bottom of the grid. Additionally, users often group like content into the same vertical column. So, for example, a user might highly value news and entertainment content, and therefore may place modules about news and entertainment in the rows highest on the grid (i.e., on a portion of the screen that is visible without having to scroll). All news items might then be grouped into one column, with the most important news items appearing in the top one to three row positions in that column. At the same time all entertainment content might be grouped in the next column (i.e., the first row might have one news item and one entertainment item, the second row one news item and one entertainment item, and so on). In an exemplary implementation, such a grid can be mapped to a wheel-based mobile device user interface such that the data modules in one column on the web page are arranged as data tiles on one wheel on the wheel-based user interface. The wheels are then arranged such that the left-most column corresponds to the top-most wheel.

FIG. 8 illustrates a wheel-based structure 802, and a grid-based web page 804. Structure 806 illustrates a mapping between grid-based web page 804 and wheel-based structure 802. As shown, the data tiles in the left-most column (1A, 1B, 1C, and 1D) of the web page 804 are mapped to the top-most wheel. Similarly, the data tiles in the next column to the right are mapped to the next wheel down; and so on. FIG. 8 also illustrates the dynamic nature of each wheel in the wheel-based structure 802. That is, the number of data tiles associated with each wheel is not limited, and each wheel can have a different number of tiles than the other wheels.

In an exemplary implementation, the top wheel is a search wheel that includes multiple data tiles, each representing a different type of search that may be performed. For example, as illustrate in FIG. 6, data tiles 606, 608, 610, 612, and 614 make up the top wheel, and each represents a different type of search. Data tile 606 provides a mechanism for executing a search of the web; data tile 608 provides a mechanism for executing a search of news; data tile 610 provides a mechanism for executing a search of images; data tile 612 provides a mechanism for executing a search of feeds; and data tile 614 provides a mechanism for executing a local search based on zip code.

Furthermore, search data tiles 606, 608, 610, 612, and 614 may support a slightly different user interaction than has been described thus far herein. For example, search data tiles 606, 608, 610, 612, and 614 may enable a user to enter data into the search box without having to first select and expand the data tile. Furthermore, when the cursor is in the search box, received left and right commands may cause the cursor to move sequentially through letters in the search box, and then, when the end of the text is reached (left or right), an additional command would then cause the wheel to spin.

In an exemplary implementation in which the top wheel, by default, is the search wheel, mapping to a web page may differ slightly. For example, if the wheel-based user interface maps to a modular web page, as described above with reference to FIG. 8, then the left-most column on the web page maps to the second wheel on the wheel-based UI (i.e., the first wheel below the default search wheel).

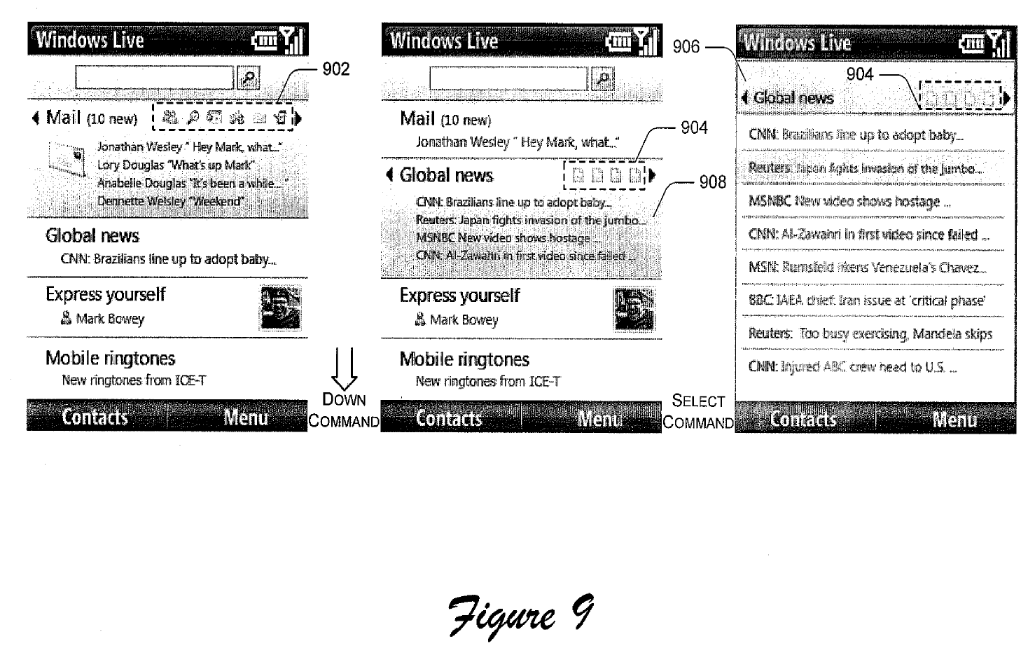

FIG. 4 illustrates an exemplary wheel position indicator 422 that provides a visual indicator of the currently displayed tile's position on the wheel. Wheel position indicator 422 is implemented as a series of dots, with the dot associated with the current tile shown larger and brighter than the other dots. FIG. 9 illustrates alternate wheel position indicators 902 and 904 that in addition to providing a visual indicator of the currently displayed tile's position on the wheel, also provide a visual indicator of the type of data available on each of the data tiles on the wheel. For example, wheel position indicator 902 is implemented as a series of icons, each representing a type of data available on a particular tile associated with the current wheel. The icons of wheel position indicator 902 each represent a type of application (e.g., email, instant messaging, search, calendar, etc.). Similarly, wheel position indicator 904 is also implemented as a series of icons representing a type of data available on each tile of the current wheel. Each of the icons of wheel position indicator 904 represents a document (e.g., a web page). FIG. 9 also illustrates display of the wheel position indicator 904 in a detailed view 906 of data tile 908.

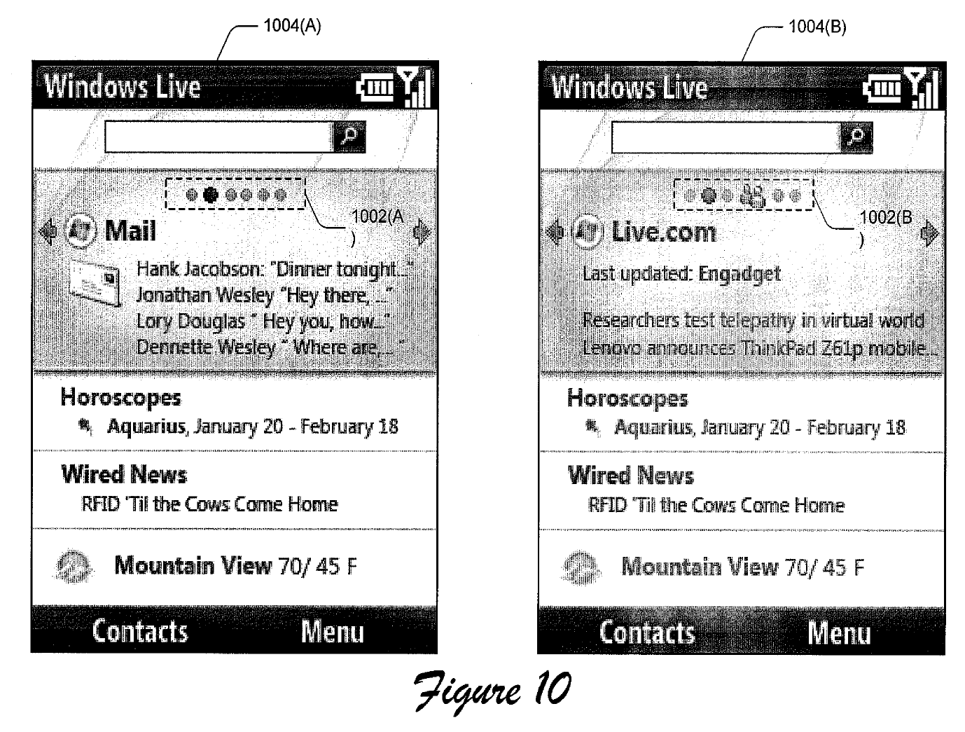

FIG. 10 illustrates an alternate wheel position indicator 1002 via which alerts can be visually presented. For example, the second wheel of mobile device user interface 1004(A) includes wheel position indicator 1002(A) made up of a series of dots, which appears similar to wheel position indicator 422 described above with reference to FIG. 4. At a later time (represented by mobile device user interface 1004(B)), the wheel position indicator 1002(B) on the second wheel is also made up of a series of dots, but also includes an icon in place of one of the dots. In an exemplary implementation, a dot may be replaced with an icon as a visual indicator of a user alert. For example, the icon shown in wheel position indicator 1002(B) may be used to indicate that a new instant message has been received.

In an exemplary implementation, the wheel-based mobile device user interface provides various ways in which a user can customize the user interface. For example, colors, themes, fonts, and font size may be selected for the user interface as whole, for individual wheels, and/or for individual data tiles. The order in which the wheels are positioned may also be customized. Similarly, the order of data tiles on a wheel may be customized. The number of wheels may also be customized. For example, a user may be allowed to add and/or delete wheels, possibly within constraints of a minimum and/or maximum number of allowed wheels. Additionally, users may be allowed to customize the display size of the wheels, which may affect the maximum number of allowed wheels. For example, if the user chooses a smaller display size for the currently non-selected wheels, one or more additional wheels may be able to be simultaneously displayed on the screen. Finally, a user may be allowed to select which data tiles are displayed on each of the wheels. This may include moving a data tile from one wheel to another, adding a data tile to a wheel, and/or deleting a data tile from a wheel. It is also recognized that various other types of customization options for the wheel-based user interface may also be implemented.

Methods for implementing a mobile device user interface may be described in the general context of computer executable instructions. Generally, computer executable instructions include routines, programs, objects, components, data structures, procedures, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

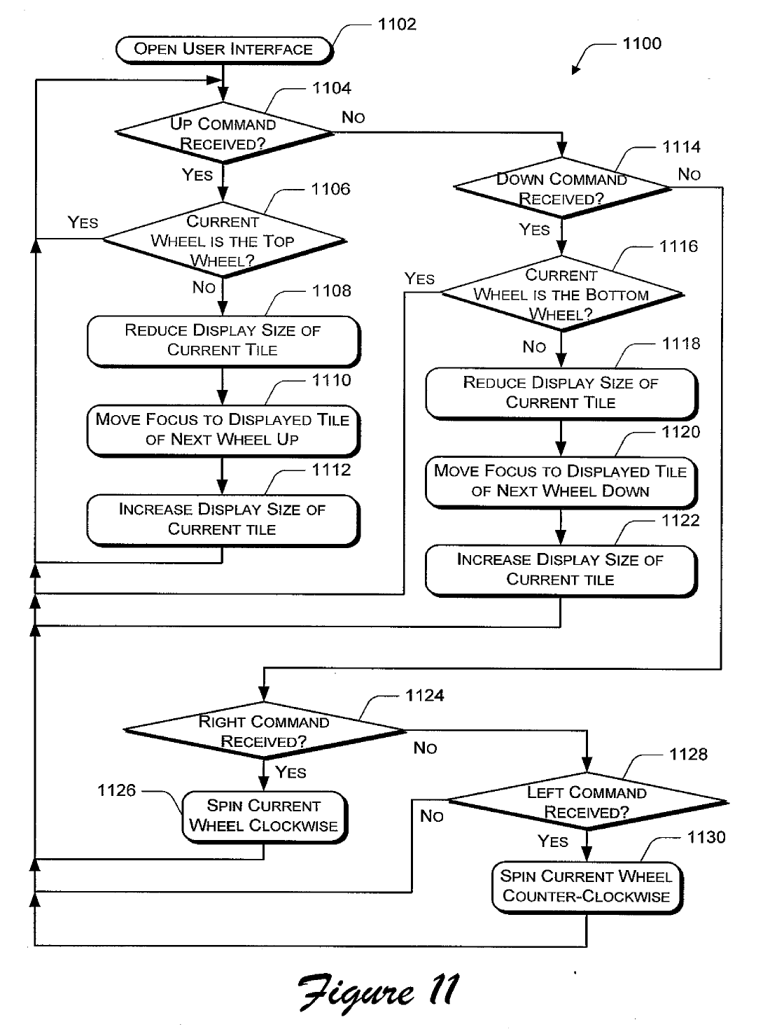

FIG. 11 illustrates an exemplary method for implementing a mobile device user interface. FIG. 11 is a specific example of implementing a mobile device user interface, and is not to be construed as a limitation. The order in which the method blocks are described is not intended to be construed as a limitation, and any number of the described method blocks can be combined in any order to implement the method. Furthermore, the method can be implemented in any suitable hardware, software, firmware, or combination thereof.

At block 1102, a user interface is opened. For example, a user selects a menu item or presses a particular button to launch an aspect of user interface application 226.

At block 1104, it is determined whether or not an up command has been received. For example, user interface application 226 monitors navigation keys 210 to determine whether or not the up arrow button has been pressed. If it is determined that an up command has been received (the “Yes” branch from block 1104), then at block 1106, it is determined whether or not the current wheel is the top wheel. For example, user interface application 226 determines the position of the wheel associated with the data tile that currently has focus. If it is determined that the current wheel is the top wheel (the “Yes” branch from block 1106), then processing continues as described above with reference to block 1104.

On the other hand, if it is determined that the current wheel is not the top wheel (the “No” branch from block 1106), then at block 1108, the display size of the current data tile is reduced; at block 1110, focus is moved to the displayed data tile above the current data tile; and at block 1112, the display size of the newly identified current data tile is increased. Processing then continues as described above with reference to block 1104.

For example, the processing described with reference to blocks 1108, 1110, and 1112 is illustrated in FIG. 5. Specifically, if data tile 504(B) currently has focus and an up command is received, the display size of data tile 504(B) is reduced, resulting in data tile 504(A); the focus is moved up to data tile 502; and the display size of data tile 502 is increased from that shown as data tile 502(B) to that shown as data tile 502(A).

If it is determined at block 1104 that an up command has not been received (the “No” branch from block 1104) then at block 1114, it is determined whether or not a down command has been received. For example, user interface application 226 monitors navigation keys 210 to determine whether or not the down arrow button has been pressed. If it is determined that a down command has been received (the “Yes” branch from block 1114), then at block 1116, it is determined whether or not the current wheel is the bottom wheel. For example, user interface application 226 determines the position of the wheel associated with the data tile that currently has focus. If it is determined that the current wheel is the bottom wheel (the “Yes” branch from block 1116), then processing continues as described above with reference to block 1104.

On the other hand, if it is determined that the current wheel is not the bottom wheel (the “No” branch from block 1116), then at block 1118, the display size of the current data tile is reduced; at block 1120, focus is moved to the displayed data tile below the current data tile; and at block 1122, the display size of the newly identified current data tile is increased. Processing then continues as described above with reference to block 1104.

For example, the processing described with reference to blocks 1108, 1110, and 1112 is illustrated in FIG. 5. Specifically, if data tile 502(A) currently has focus and a down command is received, the display size of data tile 502(A) is reduced, resulting in data tile 502(B); the focus is moved down to data tile 504; and the display size of data tile 504 is increased from that shown as data tile 504(A) to that shown as data tile 504(B).

If it is determined at block 1114 that a down command has not been received (the “No” branch from block 1114) then at block 1124, it is determined whether or not a right command has been received. For example, user interface application 226 monitors navigation keys 210 to determine whether or not the right arrow button has been pressed. If it is determined that a right command has been received (the “Yes” branch from block 1124), then at block 1126, the current wheel is spun in a clockwise direction to reveal the next data tile on the wheel. For example, as shown in FIG. 4, if data tile 404 currently has the focus and a right command is received, the wheel is spun in a clockwise direction such that data tile 412 is then displayed.

If it is determined at block 1124 that a right command has not been received (the “No” branch from block 1124) then at block 1128, it is determined whether or not a left command has been received. For example, user interface application 226 monitors navigation keys 210 to determine whether or not the left arrow button has been pressed. If it is determined that a left command has been received (the “Yes” branch from block 1128), then at block 1130, the current wheel is spun in a counter-clockwise direction to reveal the next data tile on the wheel. For example, as shown in FIG. 4, if data tile 404 currently has the focus and a left command is received, the wheel is spun in a counter-clockwise direction such that data tile 420 is then displayed.

Although embodiments of a mobile device user interface have been described in language specific to structural features and/or methods, it is to be understood that the subject of the appended claims is not necessarily limited to the specific features or methods described. Rather, the specific features and methods are disclosed as exemplary implementations of a mobile device user interface.

1. A method comprising:
arranging a plurality of data tiles as a vertical stack of horizontal wheels, wherein each wheel comprises one or more data tiles;
simultaneously displaying one data tile from each of a plurality of the wheels;
navigating from one wheel to another wheel in response to a received up or down command; and
navigating from one data tile on a particular wheel to another data tile on the particular wheel by spinning the particular wheel in a clockwise or counter-clockwise direction respectively in response to a received right or left command.

2. The method as recited in claim 1, wherein a particular one of the displayed data tiles comprises a visual wheel position indicator.

3. The method as recited in claim 2, wherein the visual wheel position indicator comprises at least one of;
a grouping of dots wherein each dot represents a particular data tile associated with a particular wheel; or
a grouping of icons wherein each icon represents a type of data available on a particular data tile associated with a particular wheel.

4. The method as recited in claim 1, wherein simultaneously displaying one data tile from each of a plurality of the wheels comprises:
identifying a current data tile associated with one of the plurality of the wheels;
associating a first display size with the current data tile;
associating a second display size with one data tile from each of the remaining of the plurality of the wheels; and
displaying the current data tile according to the first display size while simultaneously displaying the one data tile from each of the remaining of the plurality of the wheels according to the second display size.

5. The method as recited in claim 1, wherein one of the plurality of wheels comprises a search wheel such that a first data tile of the search wheel enables a first type of search and a second data tile of the search wheel enables a second type of search.

6. The method as recited in claim 1, further comprising:
receiving a select command in association with a particular one of the simultaneously displayed data tiles; and
in response to the select command, displaying a detailed view of data represented by the particular one of the simultaneously displayed data tiles.

7. The method as recited in claim 6, further comprising:
receiving a right or left command;
identifying a current wheel as a wheel associated with the data tile that represents the data currently displayed in the detailed view; and
navigating from the currently displayed detailed view to a detailed view of data represented by another data tile associated with the current wheel by spinning the current wheel in a clockwise or counter-clockwise direction respectively in response to the received right or left command.

8. The method as recited in claim 1, farther comprising arranging the wheels according to a user-specified wheel order.

9. The method as recited in claim 1, further comprising arranging the data tiles of a particular wheel according to a user-specified data tile order.

10. The method as recited in claim 1, further comprising responding to a user-submitted command by performing at least one of:
generating a wheel;
deleting a wheel;
adding a data tile to a wheel;
deleting a data tile from a wheel; or
moving a data tile from a first wheel to a second wheel.

11. A mobile device configured to implement the method as recited in claim 1.

12. The method as recited in claim 1, wherein the data tiles associated with a particular wheel correspond to data modules associated with a particular column on a web page.

13. A method comprising:
identifying a web page comprising data to be displayed via a mobile device user interface, wherein the web page presents the data arranged as a series of rows and columns of data modules;
determining a number of columns associated with the web page;
generating the mobile device user interface to include a stack of wheels, wherein the number of wheels is equal to or greater than the number of columns;
identifying data modules associated with a first column of the web page;
identifying a first wheel of the mobile device user interface; and
associating the data modules associated with the first column of the web page with data tiles associated with the first wheel of the mobile device user interface.

14. The method as recited in claim 13, wherein the stack of wheels is arranged such that the wheel corresponding to the left-most column is the top wheel in the stack.

15. The method as recited in claim 13, wherein the data modules associated with the fist column of the web page are associated with the first wheel of the mobile device user interface such that left/right navigation to spin the first wheel of the mobile device user interface mimics up/down navigation along the first column of the web page.

16. One or more computer-readable media comprising computer-executable instruction that, when executed, direct a computing device to output a user interface having a plurality of data tiles arranged as a stack of multiple horizontal wheels, wherein:
one data tile from each of the multiple wheels are simultaneously displayed;
up/down navigation provides navigation from one wheel to another wheel; and
left/right navigation provides navigation among multiple data tiles associated with a particular wheel, by spinning the particular wheel independent from the others of the multiple wheels.

17. The one or more computer-readable media as recited in claim 16, further comprising computer-executable instruction that, when executed, direct the computing device to output a user interface displaying a detailed view of a selected one of the simultaneously displayed data tiles.

18. The one or more computer-readable media as recited in claim 16, further comprising computer-executable instruction that, when executed, direct the computing device to:
maintain user interface data;
terminate output of the user interface having the plurality of data tiles arranged as a stack of multiple wheels; and
at a later time, output the user interface having the plurality of data tiles arranged as a stack of multiple horizontal wheels, based on the user interface data such that the appearance of the user interface structure is unchanged from an immediately previous display of the user interface.

19. The one or more computer-readable media as recited in claim 18, wherein the user interface data identifies at least one of:
relative positions of each of the wheels in the user interface;
relative positions of each of the data tiles in each of the wheels in the user interface; or
user preferences.

20. The one or more computer-readable media as recited in claim 19, wherein the user preferences comprise at least one of:
a color associated with at least one of a data tile or a wheel;
a theme associated with at least one of a data tile or a wheel; or
a display size of a wheel.
